(19) United States
(12) Patent Application Publication
(10) Pub. No.: US 2005/0186868 A1
(43) Pub. Date: Aug. 25, 2005

(54) Method for the production of resin prepregs with liquid reinforcer for non-woven or textile material and components made from said resin prepregs

(76) Inventors: Karlheinz Horsting, Karlsruhe (DE); Rudolf Kohfusz, Gondalsheim (DE); Gerhard Steger, Weisloch (DE)

Correspondence Address: FULBRIGHT & JAWORSKI, LLP, 666 FIFTH AVE, NEW YORK, NY, 10103-3198, US

(21) Appl. No.: 10/507,403

(22) PCT Filed: Mar. 17, 2003
(86) PCT No.: PCT/EP03/02774

(30) Foreign Application Priority Data
Mar. 21, 2002 (DE) 102 12 414.0
Mar. 5, 2003 (DE) 103 09 806.2

(51) Int. Cl. B32B 17/02; B32B 17/04

(52) U.S. Cl. 442/59; 442/327; 442/172

(57) ABSTRACT

In conventional methods for the production of components from resin prepregs made from fibre-reinforced plastics and sheet moulding compounds (SMCs), individual strips of varying lengths are cut from one or several rolls of semi-finished material. According to the form and size of the component the strips are laid adjacent to each other. A laminated pre-form is then produced by superimposing the strip sections of varying lengths with differing orientations for the individual layers in relation to the expected loadings, then laid in a press and moulded to give a component by flow moulding. According to the invention, the production of components made from SMC may be simplified and considerable styrol vaporisation on using unsaturated polyester resins may be avoided, whereby the material reinforcement for the resin prepreg comprises at least one layer of crossed fibres, which can also be a textile structure. The alignment of said fibres, the fibre orientation, is determined by the loading generated by the forces acting on the component.

The invention relates to a process for producing resin-impregnated mats from fibre-reinforced plastics—sheet-moulding compounds (SMCs)—and also for producing components from these resin-impregnated mats.

A process for producing components from superimposed resin-impregnated mats consisting of fibre-reinforced plastics, SMCs, is known from DE 199 49 318 A1. To begin with, the resin-impregnated mats with unidirectional fibre orientation are wound as semi-finished products onto rolls. In the course of the production of a component, individual strips for the structure of a layer of the component are each severed, in varying lengths and with varying directions of cut relative to the run of the fibres, from a roll of semi-finished product or from several rolls of semi-finished product. The strips are juxtaposed with a particular fibre orientation, according to the shape and size of the component. Subsequently, by superimposing the strip sections of varying length, a laminated preform having varying orientations of the individual layers in relation to the loading to be expected is formed and then inserted into a tool and shaped out into a component by extrusion. Because several superimposed layers with appropriate fibre orientations are required for an optimal design of the component, the structure of a laminate is very complex. Depending on the stress demands arising and on the size of a component, more than five individual layers may be required for an optimal structural design of a component. Relatively large bodywork parts of an automobile—such as doors or engine-compartment and luggage-compartment covers, for example—may then consist of more than a hundred and fifty individual strips, representing a considerable effort in terms of time in the course of laying.

The cutting to size and the laying of the individual strips is costly in terms of time, by reason of the manual labour involved. Automation is very difficult, on account of the complex structure of the components. In addition, there is the problem of the evaporation of styrene in the course of processing unsaturated polyester resins, which has a highly detrimental effect on the quality of the components.

The object of the invention is to present a simplified process for producing resin-impregnated mats that are suitable for multidirectional loading from fibre-reinforced plastics, and also to present a simplification of the production of large-area components from resin-impregnated mats.

The object is achieved with the aid of fibre-reinforced plastics in the form of resin-impregnated mats, SMCs, with a reinforcement of non-woven fabric that comprises at least one layer of fibres intersecting in a pattern which resembles a textile structure, the alignment of the fibres, the fibre orientation, being matched to the loading. As a rule, further layers of fibres having a different alignment are added. The components can be produced automatically by cutting the mats to size using computer-controlled cutting machines and by laying the precut blanks into the press by means of computer-controlled handling devices. With the aid of appropriate computer programs it is possible for the path of each individual blank, from the roll to its position in the component, to be tracked, enabling production to be monitored continuously, and, in the event of faults occurring in the course of the production of a component or in the event of defects arising later, enabling the cause to be ascertained.

In the known resin-impregnated mats the reinforcement consists of unidirectionally aligned fibres, aligned in the longitudinal direction of the mat, and also, where appropriate, additionally of short fibres in a random-laid layer. For the production of a component, therefore, for each direction of loading the blanks have to be laid with an orientation of the fibres corresponding to the loading in the component. In the case of the invention, on the other hand, the fibres that constitute the essential element of the reinforcement are already arranged in such a way that they run in a direction in which the forces acting on the component take effect. Production of the mats according to the invention is undertaken, in principle, as in the case of the conventional mats. The fibres, which are firstly introduced into the textile structure in the form of virtually endless fibres—that is to say, threads—are laid in such a way that the fibres in the textile structure intersect at a previously defined angle. The run of the fibres is substantially adapted to the course of the loading to be expected. In the case of shear stresses, for example, an angle of intersection of the fibres of 45 degrees is advantageous. As a rule, fibres in a different alignment, preferably in the longitudinal direction of the webs, are added and form the non-woven-fabric reinforcement. The superimposed fibres—both the unidirectionally aligned fibres, fibres running in the longitudinal direction of the mat, and the intersecting fibres—may be joined to one another at their points of intersection by means of processes that are matched to their respective material, for example by gluing, fusing or sewing. The customary materials for fibre-reinforced plastics, for example glass, carbon, aramide or HD polyethylene (HD=high-density), are used as materials for the fibres. As in the case of the conventional fibre mats, the fibre-reinforced plastic composition located between two backing films firstly passes through a fulling zone for the purpose of impregnating the reinforcing fibres.

Subsequently the material is cut into strips, wound onto rolls and transported in the form of semi-finished product into a maturing warehouse. After the requisite thickening of the semi-finished product has been attained, cutting of the quasi-endless fibres, the threads, into fibres of finite length is undertaken, in order to make the mats suitable for extrusion.

By virtue of the resin-impregnated mat according to the invention the requisite number of blanks is reduced considerably, for the blanks can already be cut out from the web, which has been drawn off from a roll, in the dimensions of the component. The requisite number of blanks to be superimposed for the design of the component in line with the directions of loading to be expected is distinctly reduced. In addition, as is already known in the case of sheet-metal blanks, the blanks can be created automatically by computer-controlled cutting machines, and these blanks are capable of being manipulated by automatic handling devices, by robots. By virtue of the significantly smaller number of blanks, the problem of the evaporation of styrene in the case where use is made of unsaturated polyester resins is no longer acute.

The invention will be elucidated in more detail on the basis of an exemplary embodiment. Shown are:

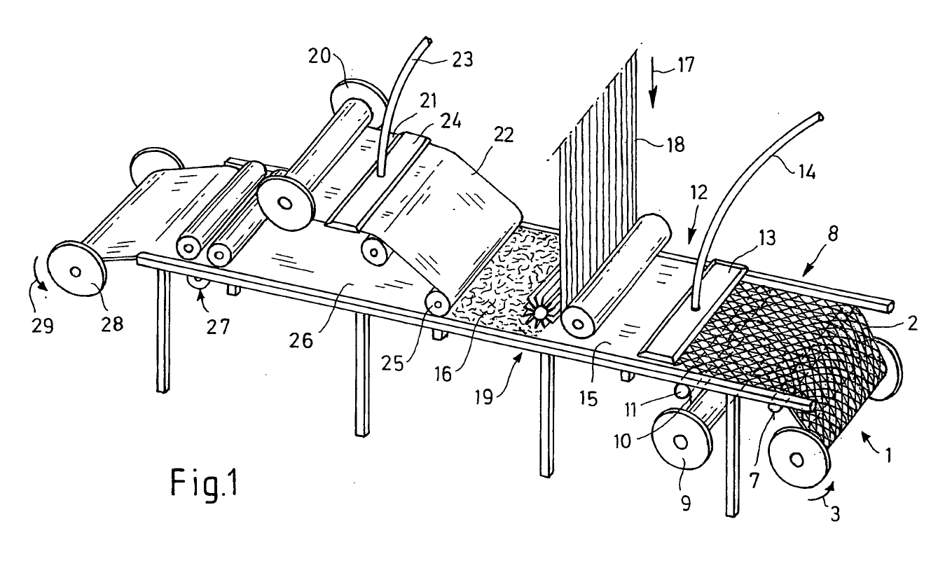

FIG. 1 the production of a resin-impregnated mat according to the invention,

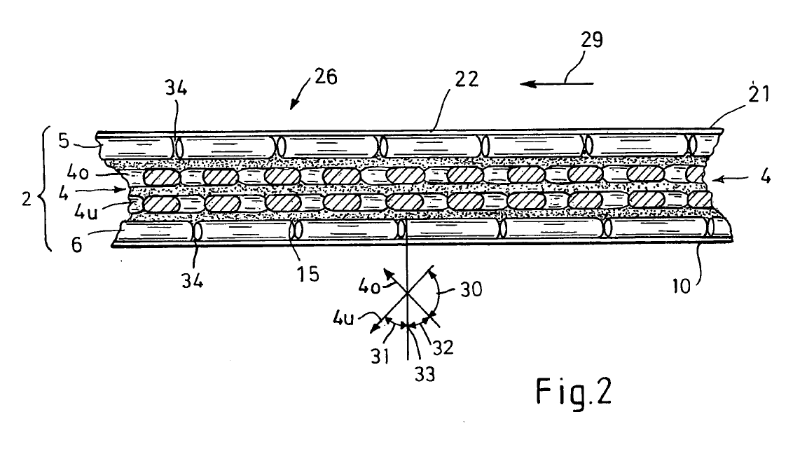

FIG. 2 a longitudinal section through a resin-impregnated mat according to the invention, and

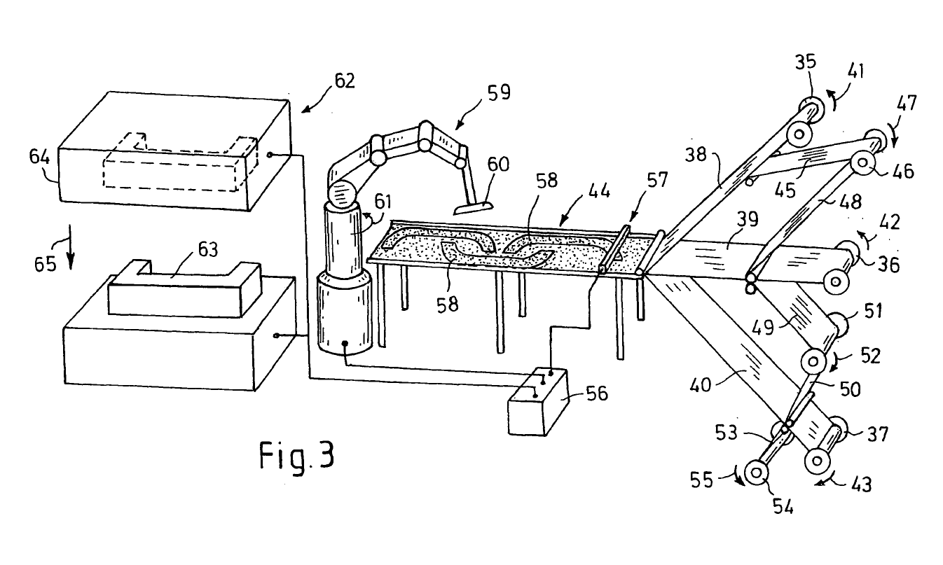

FIG. 3 the production of a component from blanks of these resin-impregnated mats.

FIG. 1 shows, in schematic representation, the production of a resin-impregnated mat by the process according to the invention. A non-woven-fabric reinforcement 2 of the mat to be formed is drawn off from a roll 1 in the direction of the arrow 3. In the present exemplary embodiment this non-woven-fabric reinforcement 2 consists of three layers, of a laying of fibres, as can be gathered from the structure of the mat shown in FIG. 2. The layer of fibres 4, which forms a rhombic pattern resembling a textile structure in which the fibres are already aligned with the loading to be expected, forms the core of the mat. Situated above and below this textile structure 4 are parallel fibres 5 and 6, respectively (FIG. 2), extending unidirectionally in the draw-off direction 3, which are particularly suitable for absorbing tensile forces extending in their direction. Via a deflection roller 7 the reinforcement 2 is drawn onto a table 8. A backing film 10 is drawn off from a roll 9 and guided up to the reinforcement 2 from below via a deflection roller 11. In the impregnating region 12 a conventional resin/filler mixture 15, for example a thermosetting system based on an unsaturated polyester resin, which is supplied via the pipe 14 is applied onto the backing film 10 by means of a doctor blade 13 and is pressed into the reinforcement 2.

In the present exemplary embodiment a layer of random fibres 16 is additionally applied, to which end threads 18 guided in the feed direction 17 are cut up in a cutter 19 into short pieces of fibre and are spread onto the resin/filler mixture 15 in random orientation in the form of a layer 16. This manufacturing step is dependent on the particular application—that is to say, it is possible but is not necessary.

The covering film 21 is now drawn off from a roll 20 and is coated here by doctor blade with thermosetting plastics 22 which are supplied to the doctor blade 24 through the pipe 23. The covering film 21 which has been prepared in such a way is pressed onto the resin-impregnated mat 26 by means of a roller 25.

After passing through the fulling zones 27, symbolised by rollers, for the purpose of impregnating the reinforcement 2, the resin-impregnated mat 26 according to the invention is wound in its entire width as a semi-finished product onto a roll 28, as indicated by the arrow 29. But the resin-impregnated mat may also be cut lengthways beforehand into narrower strips, and the individual strips may each be wound onto a roll. The fully wound rolls are transported into a maturing warehouse. After maturing, in the case of the resin-impregnated mats according to the invention—as in the case of the conventional resin-impregnated mats—the “quasi-endless” fibres, the threads, are cut into pieces in order to make the resin-impregnated mats suitable for the extrusion process.

A longitudinal section—that is to say, a section extending in the winding direction 29—through a resin-impregnated mat 26 according to the invention is represented on an enlarged scale in FIG. 2. In the present exemplary embodiment the layer of random fibres 16 is absent. Parallel fibres 6 arranged in the longitudinal direction are situated on the backing film 10. Situated above them is a layer of fibres 4 formed from fibres 4o and 4u intersecting, in the present exemplary embodiment, at an angle of intersection 30 of 80 degrees, which therefore include the complementary angle 31 and 32, respectively, to the perpendicular 33 to the winding direction 29, as the top view, drawn out of the mat, of the point of intersection of two fibres 4o and 4u shows. Situated above the intersecting fibres 4o and 4u is a further layer of fibres 5, likewise arranged parallel and in the longitudinal direction—that is to say, in the winding direction 29. In the present exemplary embodiment the fibres 5 and 6 and also the fibres 4o and 4u intersecting diagonally are produced from carbon fibres and jointly form the non-woven-fabric reinforcement 2. The fibres of the non-woven-fabric reinforcement 2 are embedded in a resin/filler mixture 15. The resin-impregnated mat 26 is covered by the covering film 21 which has been coated by doctor blade on its underside with a thermosetting plastic 22. As is evident from FIG. 2, at the separation points 34, in particular of the fibres 5 and 6, the fibres have been cut into sections of approximately equal length, in order to prepare the resin-impregnated mat 26 for the extrusion process.

In FIG. 3 the process according to the invention for producing a component from the resin-impregnated mats according to the invention is elucidated on the basis of a schematic representation. From three rolls 35, 36 and 37 the resin-impregnated mats according to the invention are drawn off in the form of webs 38, 39 and 40, respectively, in the direction of the arrows 41, 42 and 43, respectively. The resin-impregnated mats are brought together and laid in superimposed manner on a table 44. The films are peeled off from the mats beforehand. In order that the resin-impregnated mats do not adhere to the table, the latter may be coated with a material or covered with a film. The backing film 45 is peeled off from the web 38 and wound onto a roll 46, as indicated by the arrow 47. Both the covering film 48 and the backing film 49 are peeled off from the web 39. Whereas the covering film 48 is wound jointly with the backing film 45 onto a roll 46, the backing film 49 is wound jointly with the covering film 50 of the web 40 onto a roll 51, as indicated by the arrow 52. The backing film 53 of the web 40 is wound onto its own roll 54, as indicated by the arrow 55.

On the table 44 the three resin-mat webs 38, 39 and 40 are superimposed. Each of these mats has a reinforcement with a textile structure, in which connection the patterns of these structures, not represented here, may be variable and may be selected appropriately for the designated loading case. On the table 44 the blanks 58 are cut out, by means.

1-28. (canceled)

29. A process for producing resin-impregnated mats from fiber-reinforced plastics, sheet-molding compounds (SMCs), for use as semi-finished products in the production of components by the extrusion process, comprising forming a non-woven-fabric reinforcement of a resin-impregnated mat from at least one layer of intersecting endless fibers which resembles a textile structure, the alignment of these fibers, the fiber orientation, being matched to the loading by the forces acting on the component, wherein the non-woven-fabric reinforcement is drawn off in one piece from a roll and after impregnation with the resin is cut to size in accordance with the given contour.

30. The process according to claim 29, wherein the non-woven-fabric reinforcement is additionally built up from layers of fibers having a different alignment.

31. The process according to claim 29, wherein at least one layer of unidirectionally aligned fibers is introduced into the non-woven-fabric reinforcement of the resin-impregnated mat.

32. The process according to claim 29, wherein the fibers of the textile structure and, optionally the other fibers of the non-woven fabric are aligned in relation to the effective direction of individual forces.

33. The process according to claim 29, wherein the fibers of the textile structure and, where appropriate, the other fibers of the non-woven fabric are joined to one another at their points of intersection.

34. The process according to claim 29, wherein the fibers of the textile structure in the non-woven-fabric reinforcement are laid onto one another at an angle of intersection that corresponds to the angles of intersection of conventional textile structures.

35. The process according to claim 29, wherein in the case of a thrust loading of the component the fibers of the textile structure are laid at an angle of intersection of 45 degrees.

36. The process according to claim 29, wherein the resin-impregnated mat is built up from several layers of a non-woven-fabric reinforcement which each exhibit a textile structure.

37. The process according to claim 36, wherein in the individual layers the angles of intersection of the fibers of the textile structures are chosen to be different.

38. The process according to claim 29, further comprising introducing at least one layer of random fibers is introduced into the resin-impregnated mat.

39. The process according to claim 29, wherein the fibers are produced from glass, carbon, aramide or HD polyethylene.

40. The process according to claim 29, wherein the fibers in the resin-impregnated mat are prepared for a flow.

41. A resin-impregnated mat produced by the process according to claim 29, wherein the non-woven-fabric reinforcement of the resin-impregnated mat comprises at least one layer of intersecting endless fibers which resembles a textile structure, the alignment of these fibers, the fiber orientation, being matched to the loading by the forces acting on the component.

42. The resin-impregnated mat according to claim 41, wherein the non-woven-fabric reinforcement is additionally built up from layers of fibers having a different alignment.

43. The resin-impregnated mat according to claim 41, wherein at least one layer of unidirectionally aligned fibers has been introduced into the non-woven-fabric reinforcement of the resin-impregnated mat.

44. The resin-impregnated mat according to claim 41, wherein the fibers in the textile structure and, optionally, the other fibers in the non-woven fabric are aligned in relation to the effective direction of individual forces.

45. The resin-impregnated mat according to claim 41, wherein the fibers of the textile structure and, optionally, the other fibers of the non-woven fabric are joined to one another at their points of intersection.

46. The resin-impregnated mat according to claim 41, wherein the fibers in the textile structure of the non-woven-fabric reinforcement are laid onto one another at an angle of intersection that corresponds to conventional textile structures.

47. The resin-impregnated mat according to claim 41, wherein in the case of a thrust loading of the component the fibers of the textile structure are laid at an angle of intersection of 45 degrees.

48. The resin-impregnated mat according to claim 41, wherein the resin-impregnated mat is built up from several layers of a non-woven-fabric reinforcement which each exhibit a textile structure.

49. The resin-impregnated mat according to claim 48, wherein individual layers the angles of intersection of the fibers of the textile structures are different.

50. The resin-impregnated mat according to claim 48, wherein the resin-impregnated mat additionally contains at least one layer of random fibers.

51. The resin-impregnated mat according to claim 48, wherein the fibers consist of glass, carbon, aramide or HD polyethylene.

52. A process for producing components from resin-impregnated mats produced by a process of claim 29, wherein a matured resin-impregnated mat that has been prepared for extrusion, produced with a non-woven-fabric reinforcement consisting of at least one layer of intersecting endless fibers, is drawn off in the form of a web from its roll, in that the backing film and the covering film are peeled off from the web, wherein a blank having the crude contour of the component to be generated is cut out of the web, wherein this blank of the resin-impregnated mat is placed into a press, in that further blanks are generated, wherein so many blanks are placed into the press until the requisite wall thickness of the component to be generated has been attained, and the extrusion operation is then carried out in known manner.

53. A process for producing components from resin-impregnated mats produced by a process as described in claim 29, wherein matured resin-impregnated mats that have been prepared for extrusion, produced with a non-woven-fabric reinforcement consisting of at least one layer of intersecting endless fibers, are drawn off in the form of webs from rolls, wherein the backing films and covering films are peeled off from the webs, wherein the webs are superimposed in several, at least two, layers, wherein a blank having the crude contour of the component to be generated is cut out of the webs, wherein this blank comprising at least two layers of resin-impregnated mats is placed into a press, wherein so many blanks are placed into the press until the requisite wall thickness of the component to be generated has been attained, and wherein the extrusion operation is then carried out in known manner.

54. The process according to claim 52, wherein the cutting of the blanks out of the webs by means of a computer-controlled cutting device is undertaken automatically after presetting of the dimensions of the blank or of the contour of the blank.

55. The process according to claim 53, wherein the cutting of the blanks out of the webs by means of a computer-controlled cutting device is undertaken automatically after presetting of the dimensions of the blank or of the contour of the blank.

56. The process according to claim 42, wherein the blanks are picked up by means of a computer-controlled handling device and are placed into the press.

57. The process according to claim 56, wherein the cutting of the blanks out of the webs by means of a computer-controlled cutting device is undertaken automatically after presetting of the dimensions of the blank or of the contour of the blank.

58. The process according to claim 52, wherein the data relating to the composition of the resin-impregnated mats, the production date of the resin-impregnated mats, the characteristic data of the cutting device, the component number, the position of the blank in the component, the characteristic data of the press and, optionally of the handling device and also the production date of the component are stored, assigned to the component, optionally encoded in a code and optionally attached to it, and in that in the event of a production fault or in the event of damage the cause is sought on the basis of these data.

59. The process according to claim 53, wherein the data relating to the composition of the resin-impregnated mats, the production date of the resin-impregnated mats, the characteristic data of the cutting device, the component number, the position of the blank in the component, the characteristic data of the press and, optionally of the handling device and also the production date of the component are stored, assigned to the component, optionally encoded in a code and optionally attached to it, and in that in the event of a production fault or in the event of damage the cause is sought on the basis of these data.
